(19) United States
(12) Patent Application Publication
(10) Pub. No.: US 2007/0254791 A1
(43) Pub. Date: Nov. 1, 2007

(54) Calibrated rolling pin apparatus

(76) Inventor: Elaine Lee, Orlando, FL (US)

Correspondence Address: S. Michael Bender, P.O. Box 530-399, St. Petersburg, FL, 33747, US

(21) Appl. No.: 11/413,472

(22) Filed: May 1, 2006

(51) Int. Cl. B25F 5/02

(52) U.S. Cl. 492/9

(57) ABSTRACT

A calibrated rolling pin apparatus includes an axle, a rolling pin drum supported on the axle, handles attached to opposite ends of the rolling pin drum, and measurement indicia applied to portions of the rolling pin drum. The measurement indicia is visible from outside the rolling pin drum. By rolling dough with the measurement indicia in view, the user can readily measure the dimensions of the rolled dough. Preferably, the measurement indicia are formed on an outside surface of the rolling pin drum. The measurement indicia can be in a form of apothecary indicia and/or metric indicia. In addition, a level indicating device is contained within the rolling pin drum and is visible from outside the rolling pin drum through a transparent window in the drum. Also, one of the handles can be in a form of a dough embosser which is used to emboss a portion of the dough when rolled over that portion of the dough.

### BACKGROUND OF THE INVENTION

1. Field of the Invention

The present invention relates generally to food preparation implements, and, more particularly, to a rolling pin especially adapted for providing rolled dough having accurately dimensioned characteristics.

2. Description of the Prior Art

Rolling pins for rolling dough are well known in the art. A conventional rolling pin has an axle, a rolling drum supported by the axle, and a pair of handles connected to opposite sides of the axle so that the rolling drum is positioned between the handles.

It is known that many times while rolling out dough, for certain recipes such as pies, breads, and fondant, the instructions call for rolling out a circle or rectangle of specific dimensions. For example, the recipe may call for a 6 inch circle. With conventional rolling pins, cooks are left to estimate the dimensions. Alternatively, the conventional rolling pin can be placed down, and a separate and distinct ruler can be lifted up to place near the rolled dough to obtain a measurement. To avoid such inconveniences attendant to the use of conventional rolling pins, it would be desirable if a rolling pin were provided which permitted the obtaining of measurements of rolled dough without having to merely estimate dimensions or without having to employ a separate and distinct ruler for measuring dimensions.

When a separate and distinct ruler is to be used, first is must be found, second it must be used, and third it must be cleaned. In this respect, it is desirable to avoid the use of a separate and distinct ruler so that it would be unnecessary to find, use, and clean a separate and distinct ruler.

At times, it is desirable to provide rolled dough having a uniform thickness. Using a conventional rolling pin, it is often difficult to ascertain the uniformity of thickness of the rolled dough. More specifically, the naked eye of the user is most commonly employed to determine the uniformity of thickness of the rolled dough. Rather than simply relying upon the naked eye of the user, it would be desirable if a rolling pin were provided which employed an instrument for determining the uniformity of thickness of the rolled dough.

There is a device called a dough embosser that is well known for making designs on dough such as fondant used in cake decorating. The dough embosser rolls across the dough, often on the edges, leaving a design imprint on the dough. In view of the above, it would be desirable if a rolling pin were provided which can also be used as a dough embosser.

Thus, while the foregoing discussion indicates it to be well known to use conventional rolling pins, it would be desirable to provide a rolling pin apparatus which has the following combination of desirable features: (1) permits the obtaining of measurements of rolled dough without having to merely estimate dimensions or without having to employ a separate and distinct ruler; (2) makes it unnecessary to find, use, and clean a separate and distinct ruler; (3) can employ an instrument for determining the uniformity of thickness of the rolled dough; and (4) can also be used as a dough embosser. The foregoing desired characteristics are provided by the unique calibrated rolling pin apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a calibrated rolling pin apparatus includes an axle, a rolling pin drum supported on the axle, handles attached to opposite ends of the rolling pin drum, and measurement indicia applied to portions of the rolling pin drum. The measurement indicia are visible from outside the rolling pin drum. The measurement indicia have the appearance of a calibrated ruler. By rolling dough with the measurement indicia in view, the user can readily measure the dimensions of the rolled dough.

Preferably, the measurement indicia are formed on an outside surface of the rolling pin drum. The measurement indicia can be in a form of apothecary indicia. Also, the measurement indicia are in a form of metric indicia. The apothecary indicia and the metric indicia are located at diametrically opposed locations on the rolling pin drum.

In accordance with another feature of the invention, a level indicating device is contained within the rolling pin drum. Preferably, the rolling pin drum includes a transparent window, and the level indicating device is housed in the rolling pin drum behind and in registration with the transparent window. Preferably, the level indicating device is in a form of a bubble level unit.

In accordance with another aspect of the present invention, one of the handles can be in a form of a dough embosser which is used to emboss a portion of the dough when rolled over that portion of the dough.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved calibrated rolling pin apparatus which has all of the advantages of the prior art and none of the disadvantages.

It is another object of the present invention to provide a new and improved calibrated rolling pin apparatus which may be easily and efficiently manufactured and marketed.

It is a further object of the present invention to provide a new and improved calibrated rolling pin apparatus which is of durable and reliable construction.

An even further object of the present invention is to provide a new and improved calibrated rolling pin apparatus which is susceptible of a low cost of manufacture with regard to both materials and labor, and which accordingly is then susceptible of low prices of sale to the consuming public, thereby making such calibrated rolling pin apparatus available to the buying public.

Still yet a further object of the present invention is to provide a new and improved calibrated rolling pin apparatus which permits the obtaining of measurements of rolled dough without having to merely estimate dimensions or without having to employ a separate and distinct ruler.

Still another object of the present invention is to provide a new and improved calibrated rolling pin apparatus that makes it unnecessary to find, use, and clean a separate and distinct ruler.

Yet another object of the present invention is to provide a new and improved calibrated rolling pin apparatus which can employ an instrument for determining the uniformity of thickness of the rolled dough.

Even another object of the present invention is to provide a new and improved calibrated rolling pin apparatus that can also be used as a dough embosser.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a top view showing a preferred embodiment of the calibrated rolling pin apparatus of the invention.

FIG. 2 is an enlarged cross-sectional view of the embodiment of the calibrated rolling pin apparatus shown in FIG. 1 taken along line 2-2 of FIG. 1.

FIG. 3 is a bottom view of the embodiment of the calibrated rolling pin apparatus of FIG. 1.

FIG. 4 is an enlarged view of a portion of first measurement indicia, shown in circled area 4, of FIG. 1.

FIG. 5 is an enlarged view of a portion of second measurement indicia, shown in circled area 5, of FIG. 3.

FIG. 6 is an exploded perspective view of the embodiment of the invention shown in FIGS. 1-5.

### DESCRIPTION OF THE PREFERRED EMBODIMENT

With reference to the drawings, a new and improved calibrated rolling pin apparatus embodying the principles and concepts of the present invention will be described.

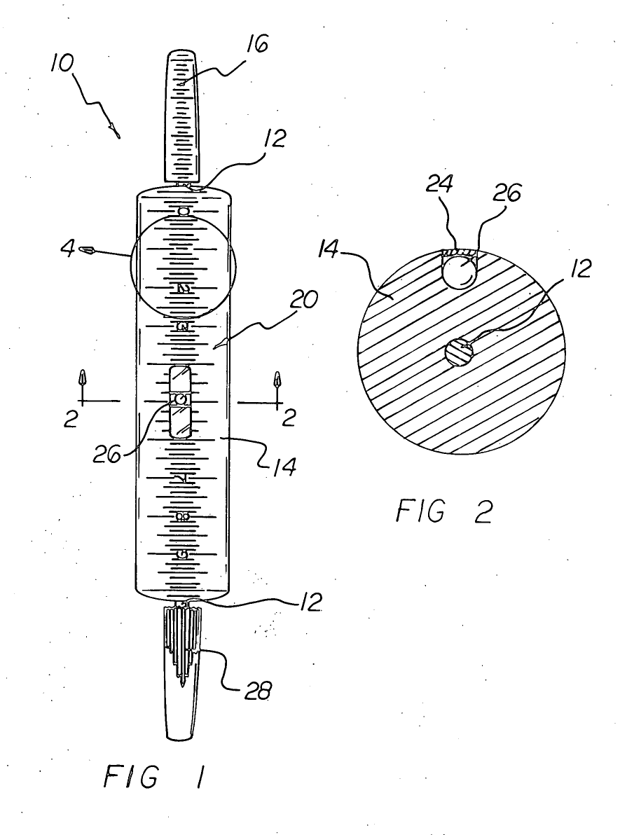

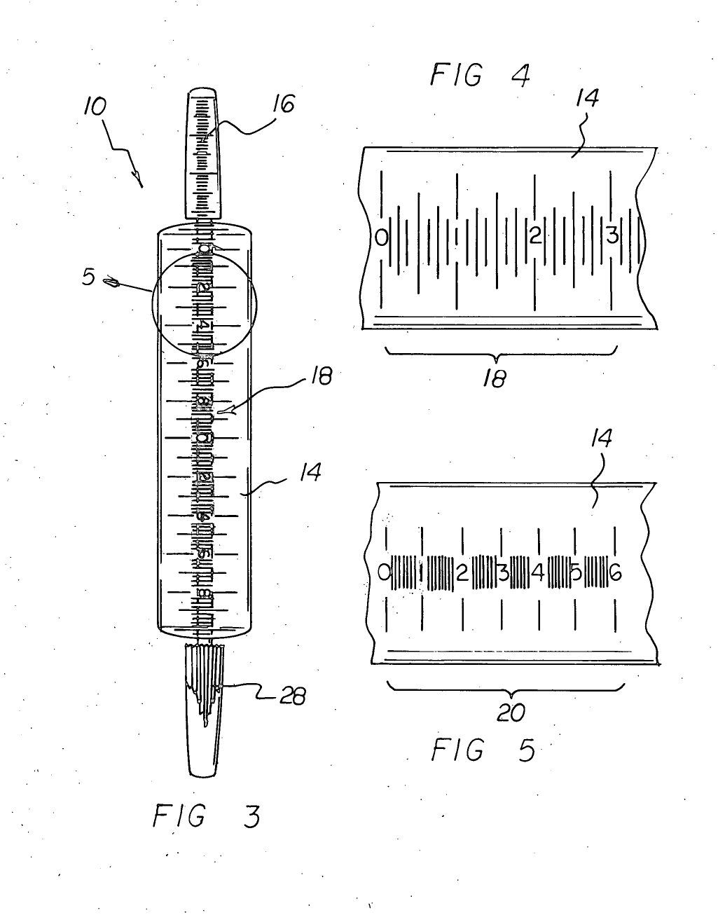

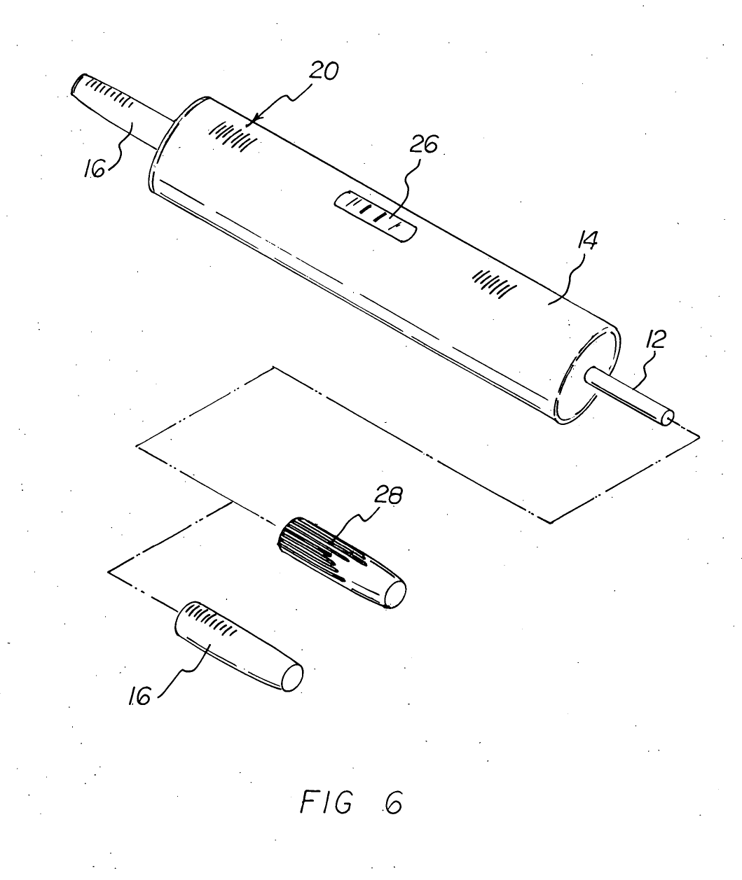

Turning to FIGS. 1-6, there is shown a preferred embodiment of the calibrated rolling pin apparatus of the invention generally designated by reference numeral 10. In each of the figures, reference numerals are shown that correspond to like reference numerals that designate like elements shown in other figures.

In the preferred embodiment, calibrated rolling pin apparatus 10 includes an axle 12, a rolling pin drum 14 supported on the axle 12, handles 16 attached to opposite ends of the rolling pin drum 14, and measurement indicia applied to portions of the rolling pin drum 14. The measurement indicia is visible from outside the rolling pin drum 14.

Preferably, the measurement indicia are formed on an outside surface of the rolling pin drum 14. The measurement indicia can be in a form of apothecary indicia 18. Also, the measurement indicia are in a form of metric indicia 20. The apothecary indicia 18 and the metric indicia 20 can be considered to be indicia of a calibrated ruler. The apothecary indicia 18 and the metric indicia 20 are located at diametrically opposed locations on the rolling pin drum 14.

In accordance with another feature of the invention, a level indicating device is contained within the rolling pin drum 14.

Preferably, the rolling pin drum 14 includes a transparent window 24, and the level indicating device is housed in the rolling pin drum 14 behind and in registration with the transparent window 24. If desired, the entire rolling pin drum 14 can be made from transparent plastic material.

Preferably, the transparent window 24 and the rolling pin drum 14 have a water-tight seal so that no water leaks behind the transparent window 24 when the calibrated rolling pin apparatus 10 is washed. Preferably, the level indicating device is in a form of a bubble level unit 26.

In accordance with another aspect of the present invention, one of the handles 16 can be in a form of a dough embosser 28.

More specifically, the dough embosser 28 can be in the form of a handle that is placed over a portion of the axle 12 that extends outwardly from the rolling pin drum 14. Alternatively, the dough embosser 28 can be in the form of a sleeve that is added over a handle 16, in the form of a jacket.

To use the embodiment of the calibrated rolling pin apparatus 10 disclosed in the drawing figures, a user grasps the handles 16 and applies the rolling pin drum 14 onto a quantity of dough (not shown). Then, the user observes either the apothecary indicia 18 or the metric indicia 20 to measure the rolled dough.

When the uniformity of thickness of the rolled dough is important, the user positions the bubble level unit 26 in a upward-facing position and places the rolling pin drum 14 on the rolled dough. When the thickness of the rolled dough is even, the bubble level unit 26 indicates a level orientation. When the thickness of the rolled dough is not of uniform thickness, the bubble level unit 26 will not be level, and further rolling of the rolling pin drum 14 can be used to make compensation.

Generally, the handles 16 can be in the form of sleeves that are placed over portions of the axle 12 that extends outwardly from the rolling pin drum 14.

When the rolling pin drum 14 is rolled over the dough, the dough embosser 28 can roll over and emboss a portion of the dough.

The rolling pin drum 14 can be made from plastic or wood. The measurement indicia can be applied to the outside surface of the rolling pin drum 14 by means of laser engraving, or any other suitable means.

The components of the calibrated rolling pin apparatus of the invention can be made from inexpensive and/or durable metal, stainless steel, marble, wood, silicone rubber, and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved calibrated rolling pin apparatus that is low in cost, relatively simple in design and operation, and which may advantageously be used to permit the obtaining of measurements of rolled dough without having to merely estimate dimensions or without having to employ a separate and distinct ruler. With the invention, a calibrated rolling pin apparatus is provided which makes it unnecessary to find, use, and clean a separate and distinct ruler. With the invention, a calibrated rolling pin apparatus is provided which can employ an instrument for determining the uniformity of thickness of the rolled dough. With the invention, a calibrated rolling pin apparatus is provided which can also be used as a dough embosser.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. Thus, for example, as will be apparent to those of ordinary skill, the principles of the calibrated rolling pin apparatus of the present invention can be applied to a so-called “French” rolling pin comprising a cylindrical member with no handles or axles.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A calibrated rolling pin apparatus, comprising:
an axle,
a rolling pin drum supported on said axle,
handles attached to opposite ends of said rolling pin drum,
measurement indicia applied to a portion of said rolling pin drum, wherein said measurement indicia is visible from outside said rolling pin drum.

2. The apparatus of claim 1 wherein said measurement indicia are formed on an outside surface of said rolling pin drum.

3. The apparatus of claim 1 wherein said measurement indicia are in a form of apothecary indicia.

4. The apparatus of claim 3 wherein said measurement indicia are in a form of metric indicia.

5. The apparatus of claim 4 wherein said apothecary indicia and said metric indicia are located at diametrically opposed locations on said rolling pin drum.

6. The apparatus of claim 1, further including:
a level indicating device contained within said rolling pin drum.

7. The apparatus of claim 6 wherein:
said rolling pin drum includes a transparent window, and
said level indicating device is housed in said rolling pin drum behind and in registration with said transparent window.

8. The apparatus of claim 6 wherein said level indicating device is in a form of a bubble level unit.

9. The apparatus of claim 1 wherein one of said handles is in a form of a dough embosser.

10. The apparatus of claim 1, further including a dough embosser fitted over one of said handles.
